(19) United States
(12) Patent Application Publication
(10) Pub. No.: US 2024/0235198 A1
(43) Pub. Date: Jul. 11, 2024

(54) LOW-VOLTAGE USER DEMAND RESPONSE INTERACTION APPARATUS AND OPERATION METHOD THEREFOR

(71) Applicants: GUANGXI POWER GRID CO., LTD., Nanning, Guangxi (CN); ELECTRIC POWER RESEARCH INSTITUTE, CHINA SOUTHERN POWER GRID, Guangzhou, Guangdong (CN)

(72) Inventors: Wenqian JIANG, Nanning, Guangxi (CN); Xiaoming LIN, Guangzhou, Guangdong (CN); Kun ZHANG, Nanning, Guangxi (CN); Bin QIAN, Guangzhou, Guangdong (CN); Zhou YANG, Nanning, Guangxi (CN); Zhitao TANG, Nanning, Guangxi (CN); Junli HUANG, Nanning, Guangxi (CN); Jinjin LI, Nanning, Guangxi (CN); Yi LUO, Guangzhou, Guangdong (CN); Jun CHEN, Nanning, Guangxi (CN); Jueyu CHEN, Nanning, Guangxi (CN); Mi ZHOU, Guangzhou, Guangdong (CN); Xiuqing LIN, Nanning, Guangxi (CN); Keying HUANG, Nanning, Guangxi (CN)

(73) Assignees: GUANGXI POWER GRID CO., LTD., Nanning, Guangxi (CN); ELECTRIC POWER RESEARCH INSTITUTE, CHINA SOUTHERN POWER GRID, Guangzhou, Guangdong (CN)

(21) Appl. No.: 18/562,355

(22) PCT Filed: Aug. 19, 2022
(86) PCT No.: PCT/CN2022/113666

§ 371 Date: Nov. 20, 2023

(30) Foreign Application Priority Data
Mar. 11, 2022 (CN) 202210236177.6

(51) Int. Cl. H02J 3/14; H04L 9/00

(52) U.S. Cl. CPC H02J 3/144; H04L 9/50

(57) ABSTRACT

A low-voltage user demand response interaction apparatus and an operation method therefor. The apparatus comprises an electrical loop, a mechanical switch, a protection module, a data collection module, a control processor, a power supply module, a communication module, a load identification module, a blockchain module and a demand response module, wherein the mechanical switch is connected to the electrical loop; the protection module is connected to the mechanical switch; the control processor is connected to the protection module; the load identification module, the blockchain module and the demand response module are respectively connected to the control processor; the data collection module is connected to the electrical loop, and transmits data to the control processor; and the communication module and the power supply module are respectively connected to the control processor.

The present application claims priority to Chinese Patent Application No. 202210236177.6, titled “LOW-VOLTAGE USER DEMAND RESPONSE INTERACTION APPARATUS AND OPERATION METHOD THEREFOR”, filed on Mar. 11, 2022 with the Chinese Patent Office, which is incorporated herein by reference in its entirety.

### FIELD

The present disclosure relates to the field of power demand response, and in particular to an interaction device for a demand response from a low-voltage user and a method for an interaction device for a demand response from a low-voltage user.

### BACKGROUND

Actively implementing management at a power demand side is conducive to improving an orderly and economical electricity system. A flexible regulation capacity of the system is improved through market means, ensuring safety of life and production, and transforming a management-type power grid to a service-type power grid. In general, large-scale industries and general commercial users, having high electricity capacity and high electricity consumption, participate in the power demand response. With the development of Internet of Things technology, general residential users and even load aggregator that aggregates a large number of medium users and small users through the network may participate in the power demand response, significantly increasing the users participating in the demand response and the total amount of available scheduling resources. The resident users are resources with great potential for demand response. The participation of the resident users in the power market may bring safe and significant economic benefits, and may significantly enhance the accommodation capacity of distributed energy resource. However, the ways for the resident users to participate in the power demand response presently are not smooth due to lack of necessary devices.

### SUMMARY

An interaction device for a demand response from a low-voltage user and a method for an interaction device for a demand response from a low-voltage user are provided according to the present disclosure. The interaction device for a demand response from a low-voltage user has advantages of small volume and intelligence, providing an effective way for the low-voltage user to participate in the demand response, and ensuring the safety and reliability of service data in the demand response.

To achieve the above objectives, the following technical solutions are provided according to the present disclosure.

An interaction device for a demand response from a low-voltage user includes: an electrical circuit, a mechanical switch, a protection module, a data acquisition module, a control processor, a power supply module, a communication module, a load determination module, a blockchain module, and a demand response module. The mechanical switch is connected to the electrical circuit, the protection module is electrically connected to the mechanical switch, and the control processor is electrically connected to the protection module. The load determination module, the blockchain module, and the demand response module are electrically connected to the control processor. The data acquisition module is connected to the electrical circuit, and is configured to transmit data to the control processor. The communication module and the power supply module are electrically connected to the control processor.

A method for an interaction device for a demand response from a low-voltage user includes: automatically turning off a mechanical switch in an abnormal situation; receiving, by a protection module, a protection signal from a control processor, and controlling, by the protection module, the mechanical switch to be turned off by using a control signal; acquiring, by a data acquisition module, information of a distribution line, and processing and transmitting, by the data acquisition module, a signal about the distribution line to the control processor; processing, by the control processor, data from the data acquisition module, and providing, by the control processor, data for the protection module, a load determination module, a blockchain module, and a demand response module; supplying, by a power supply module, power to the control processor; performing, by a communication module, data transmission with an external platform; determining, by the load determination module, the type of an electrical appliance used by the user, and determining, by the load determination module, demand response potential of the user through comparison and analysis; processing, by the demand response module, demand response information, and providing, by the demand response module, a demand response strategy for the user; and credibly recording by the blockchain module, service data in the demand response from the user, and automatically performing by, the blockchain module, settlement on the demand response according to a smart contract.

In an embodiment, the determining, by the load determination module, the type of an electrical appliance used by the user, and determining, by the load determination module, demand response potential of the user through comparison and analysis includes: decomposing a load curve of the low-voltage user based on a load determination result; and calculating the demand response potential of the low-voltage user based on regulation coefficients of various loads.

In an embodiment, the processing, by the demand response module, demand response information, and providing, by the demand response module, a demand response strategy for the user includes: receiving demand information and pushing a reminder to the low-voltage user; uploading the demand response information based on a response result from the low-voltage user; generating a demand response regulation strategy based on the demand response result and a parameter configured by the user; interacting with an intelligent gateway to execute the demand response regulation strategy; and acquiring a confirmation result and pushing the confirmation result to the user.

In an embodiment, the blockchain module is deployed with a lightweight node software package, all low-voltage users in a same district form a demand response transaction sub-chain of the district, a district terminal serves as a main node of the demand response transaction sub-chain of the district, and district terminals, major industrial and commercial users and measurement automation main stations form a demand response transaction main-chain.

The present disclosure has the following beneficial effects. An intelligent circuit breaker performs safety protection on indoor electrical of the low-voltage users, and has advantages of small volume, intelligence, and low cost. By reforming the intelligent circuit breaker, a function module for a demand response from the low-voltage user is expanded to form the interaction device for a demand response from a low-voltage user, providing an effective way for the low-voltage user to participate in the demand response. The interaction device has advantages of small size, low cost, intelligence, and high reliability. The interaction device may interact with a home intelligent gateway, a smart speaker and the like to fully mobilizing the enthusiasm of the low-voltage user to participate in the demand response, improving intelligent interaction experience of the user, providing an effective way for the low-voltage user to participate in the demand response, and ensuring the safety and reliability of service data in the demand response.

### BRIEF DESCRIPTION OF THE DRAWINGS

In order to more clearly illustrate technical solutions in embodiments of the present disclosure or in the conventional technology, the drawings to be used in the description of the embodiments or the conventional technology are briefly described below. Apparently, the drawings in the following description show only some embodiments of the present disclosure, and other drawings may be obtained by those skilled in the art from the drawings without any creative work.

FIG. 1 is a schematic structural diagram of a device according to an embodiment of the present disclosure; and

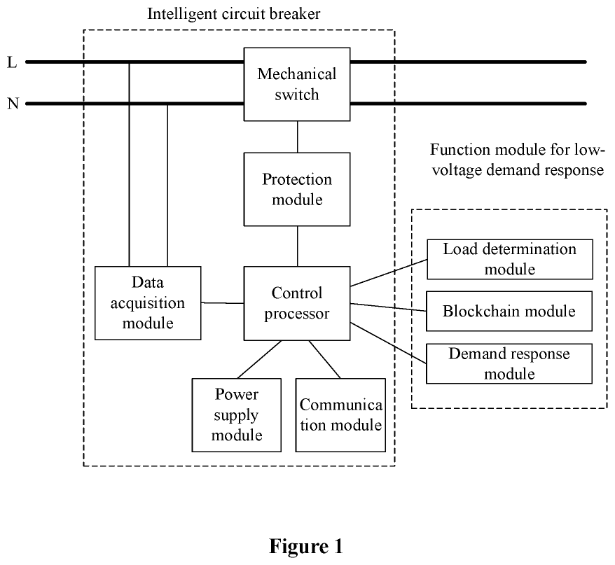

FIG. 2 is a schematic diagram showing operations of a demand response module according to an embodiment of the present disclosure.

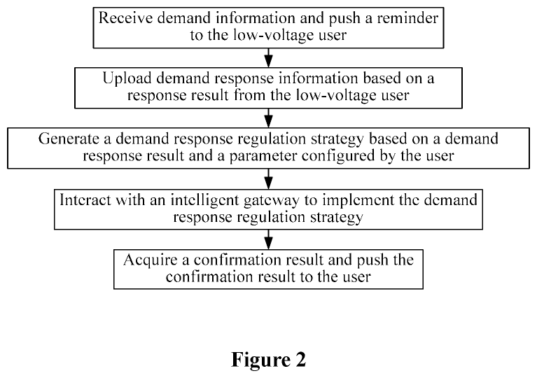

### DETAILED DESCRIPTION OF THE EMBODIMENTS

The embodiments of the present disclosure are described in detail hereinafter with reference to the drawings.

Implementations of the present disclosure are described hereinafter through specific examples. Those skilled in the art can easily understand other advantages and effects of the present disclosure from contents disclosed in this specification. Apparently, the described embodiments are only some of the embodiments of the present disclosure, rather than all of the embodiments. The present disclosure may be implemented or applied through other different embodiments. Various details in this specification may be modified or alternated based on different viewpoints and applications, without departing from the spirit of the present disclosure. It should be noted that, the embodiments of the present disclosure and features in the embodiments may be combined with each other without causing conflicts. Based on the embodiments of the present disclosure, all other embodiments obtained by those skilled in the art without any creative effort shall fall within the scope of protection of the present disclosure.

First Embodiment

An interaction device for a demand response from a low-voltage user includes: an electrical circuit, a mechanical switch, a protection module, a data acquisition module, a control processor, a power supply module, a communication module, a load determination module, a blockchain module, and a demand response module. The mechanical switch is connected to the electrical circuit. The protection module is electrically connected to the mechanical switch. The control processor is electrically connected to the protection module. The load determination module, the blockchain module, and the demand response module are electrically connected to the control processor. The data acquisition module is connected to the electrical circuit, and is configured to transmit data to the control processor. The communication module and the power supply module are electrically connected to the control processor.

A method for an interaction device for a demand response from a low-voltage user includes the following operations.

The mechanical switch is automatically turned off in an abnormal situation. The mechanical switch is connected to the electrical circuit at an indoor entrance of a distribution line of the low-voltage user. The mechanical switch is automatically turned off in the abnormal situation based on a control signal from the protection module, or is manually turned off locally or remotely.

The protection module receives a protection signal from the control processor, and controls the mechanical switch to be turned off by using a control signal.

The data acquisition module acquires information of a distribution line, processes a signal including the information of the distribution line, and transmits the processed signal to the control processor. The data acquisition module acquires a current signal, a voltage signal, and a temperature signal of the distribution line, converts an analog signal to a digital signal by using a signal processing circuit, and transmits the digital signal to the control processor.

The control processor processes data from the data acquisition module, and provides data for the protection module, the load determination module, the blockchain module, and the demand response module.

The power supply module supplies power to the control processor.

The communication module is configured to perform data transmission with an external platform.

The load determination module intelligently determinates the type of an electrical appliance used by the user based on a voltage curve and a current curve, and determines demand response potential of the user through comparison and analysis.

The demand response module is configured to process demand response information and to provide a demand response strategy for the user. The demand response module is further configured to process the demand response information and provide a personalized demand response strategy for the user based on the demand response potential of the user.

The blockchain module is configured to credibly record service data in the demand response from the user, and to automatically perform settlement on the demand response according to a smart contract.

The load determination module determines the type of the electrical appliance used by the user and determines the demand response potential of the user through comparison and analysis by:
decomposing a load curve of the low-voltage user based on a load determination result by using the following equation:

$${P}_{t} = {\sum }_{k - 1}^{K} {p}_{k , t} + {p}_{o t h e r , t}$$

where Pₜ represents a total load power of the low-voltage user at a time instant t, P_{k,t} represents a power of a k-th type of electrical appliance of the low-voltage user at the time instant t, K represents the number of types of electrical appliances, k ranges from 1 to K, and P_{other,t} represents a power of other consumption loads of the low-voltage user at the time instant t; and
calculating the demand response potential of the low-voltage user based on regulation coefficients of various loads by using the following equation:

$${Q}_{t} = {\sum }_{k = 1}^{K} {x}_{k} {p}_{k , t}$$

where Qₜ represents a power of an adjustable load of the low-voltage user at the time instant t, xₖ represents a regulation coefficient of the k-th type of electrical appliance and ranges from 0 to 1. In a case that the k-th type of electrical appliance is an interruptible load, xₖ is equal to 1. In a case that the k-th type of electrical appliance is a completely unregulated load, xₖ is equal to 0.

The demand response module processes the demand response information and provides the demand response strategy for the user by: receiving demand information and pushing a reminder to the low-voltage user; receiving a demand response time period, a capacity and other information from a demand response platform, and pushing a reminder to the low-voltage user; uploading the demand response information based on a response result from the low-voltage user; uploading a demand response quotation, a capacity, and other information to the demand response platform based on the response result from the low-voltage user; generating a demand response regulation strategy based on the demand response result and a parameter configured by the user; generating an optimal demand response regulation strategy based on the demand response result from the demand response platform and the parameter configured by the user for the user to make a decision; implementing the demand response regulation strategy by interacting with an intelligent gateway; automatically implementing the demand response regulation strategy by interacting with the intelligent gateway based on a regulation solution determined by the user; acquiring a confirmation result and pushing the confirmation result to the user; and acquiring a confirmation result from the demand response platform and pushing the confirmation result to the user.

The blockchain module is deployed with a lightweight node software package. All low-voltage users in a same district form a demand response transaction sub-chain of the district. A district terminal serves as a main node of the demand response transaction sub-chain of the district. District terminals, major industrial and commercial users, and measurement automation main stations form a demand response transaction main-chain.

Those skilled in the art may clearly understand that, for ease and simplicity of description, reference may be made to the foregoing embodiments of the method for operations of the system, apparatus and units, which are not repeated herein.

It should be understood that the system, apparatus and method disclosed in the embodiments according to the present disclosure may be implemented in other ways. For example, the embodiments of the device are only illustrative. For example, the units are defined based on logical functions, and there may be other manners in practice. For example, multiple units or components may be combined with each other, or integrated into another system; and some features may be omitted or may not be performed. In addition, the mutual coupling, direct coupling or communication connection shown or discussed may refer to an indirect coupling or communication connection via some interfaces, apparatuses or units, and may be electrical, mechanical or of other forms.

The units described as separate components may or may not be physically separated. The components shown as units may or may not be physical units, that is, the components may be located in a same location, or may be distributed to multiple network units. Some or all of the units may be implemented based on an actual need to achieve the objective of the technical solutions of an embodiment.

In addition, functional units in the embodiments of the present disclosure may be integrated into one processing unit, or may be separately exist. Two or more of the units may be integrated into one unit. Integration of the units may be implemented by hardware or in a form of a software functional unit.

In a case that the integration of the units is implemented in the form of a software functional unit, and is sold or used as an independent product, the integrated unit may be stored in a computer-readable storage medium. Based on such understanding, the essence of the technical solutions of the present disclosure, or parts of the technical solutions which contribute to the conventional technology, or all or parts of the technical solutions may be embodied in the form of a software product. The computer software product is stored in a storage medium, and includes instructions which enables a computer device (such as a personal computer, a server, or a network device) to perform all or part of the method according to the embodiments of the present disclosure. The foregoing storage medium includes a U disk, a removable hard disk, a read-only memory (ROM), a random-access memory (RAM), a magnetic disk, an optical disk, or other media that can store program codes.

1. An interaction device for a demand response from a low-voltage user, comprising: an electrical circuit, a mechanical switch, a protection module, a data acquisition module, a control processor, a power supply module, a communication module, a load determination module, a blockchain module, and a demand response module, wherein
the mechanical switch is connected to the electrical circuit, the protection module is electrically connected to the mechanical switch, and the control processor is electrically connected to the protection module;
the load determination module, the blockchain module and the demand response module are electrically connected to the control processor;
the data acquisition module is connected to the electrical circuit, and is configured to transmit data to the control processor; and
the communication module and the power supply module are electrically connected to the control processor.

2. A method for an interaction device for a demand response from a low-voltage user, comprising:
automatically turning off a mechanical switch in an abnormal situation;
receiving, by a protection module, a protection signal from a control processor, and controlling, by the protection module, the mechanical switch to be turned off by using a control signal;
acquiring, by a data acquisition module, information of a distribution line, and processing and transmitting, by the data acquisition module, a signal about the distribution line to the control processor;
processing, by the control processor, data from the data acquisition module, and providing, by the control processor, data for the protection module, a load determination module, a blockchain module, and a demand response module;
supplying, by a power supply module, power to the control processor;
performing, by a communication module, data transmission with an external platform;
determining, by the load determination module, the type of an electrical appliance used by the user, and determining, by the load determination module, demand response potential of the user through comparison and analysis;
processing, by the demand response module, demand response information, and providing, by the demand response module, a demand response strategy for the user; and
credibly recording, by the blockchain module, service data in the demand response from the user, and automatically performing, by the blockchain module, settlement on the demand response according to a smart contract.

3. The method for an interaction device for a demand response from a low-voltage user according to claim 2, wherein the determining, by the load determination module, the type of an electrical appliance used by the user, and determining, by the load determination module, demand response potential of the user through comparison and analysis comprises:
decomposing a load curve of the low-voltage user based on a load determination result; and
calculating the demand response potential of the low-voltage user based on regulation coefficients of various loads.

4. The method for an interaction device for a demand response from a low-voltage user according to claim 2, wherein the processing, by the demand response module, demand response information, and providing, by the demand response module, a demand response strategy for the user comprises:
receiving demand information and pushing a reminder to the low-voltage user;
uploading the demand response information based on a response result from the low-voltage user;
generating a demand response regulation strategy based on the demand response result and a parameter configured by the user;
interacting with an intelligent gateway to execute the demand response regulation strategy; and
acquiring a confirmation result and pushing the confirmation result to the user.

5. The method for an interaction device for a demand response from a low-voltage user according to claim 2, wherein the blockchain module is deployed with a lightweight node software package, all low-voltage users in a same district form a demand response transaction sub-chain of the district, a district terminal serves as a main node of the demand response transaction sub-chain of the district, and district terminals, major industrial and commercial users and measurement automation main stations form a demand response transaction main-chain.
